(19) United States
(12) Patent Application Publication
(10) Pub. No.: US 2004/0135019 A1
(43) Pub. Date: Jul. 15, 2004

(54) Linkage mechanism of paper-cut and anti-block of double-duty shredder

(76) Inventor: Frank Chang, Sanchung City (TW)

Correspondence Address: David E. Dougherty & MacDonald, Dennison, Schultz, Dougherty & MacDonald, 1727 King Street, Suite 105, Alexandria, VA, 22314, US

(21) Appl. No.: 10/338,670

(22) Filed: Jan. 9, 2003

(51) Int. Cl. B02C 18/24

(52) U.S. Cl. 241/236

(57) ABSTRACT

The present invention is a linkage mechanism of cut-paper and anti-block of double-duty shredders, main comprising: stripe-cutter wheel group, latitude cutter, drive shaft, paper-expeller, crank coupler link group and intermittent cluster gear, is that crank coupler link drive latitude-cutter to cut horizontally the paper to be cut, then intermittent cluster gear control the stripe-cutter wheel group to pull down the paper to be cut to act longitudinal cut, and by the circle cross movement, the paper to be cut will be cut into chips.

### FILED OF THE INVENTION

The present invention is a double-duty shredder that can shift freely between different effects of stripe-cut and cross-cut, especially provides a linkage mechanism that can realize the effect of latitude cut and longitudinal cut and anti-block.

### BACKGROUND OF THE INVENTION

Shredder, just as its name implies, a machine that cut paper into chips by mechanical cut, the more important object is to destroy the content on the paper and to keep security, besides to cut the paper into chips to decrease the quantity of the garbage to protect environment.

Shredder can be classed into two types, the stripe-cut shredders and cross-cut shredders, according to the machine cut style, the former is set blades used for cutting on revolving cut wheel to cut paper into strips, the later is the blades being provided with more than one hook-shaped edges and the edges are disposed helically around the revolving cut wheel to cut paper into strip longitudinally and cut paper into shatter of 5 mm×40 mm in latitudinal direction. Because the cut effect of later is better than the that of former, so, as to the object of environmental protection of decreasing the quantity of garbage or the effect of keep security of destroying the contents on the paper, the cross-cut shredders has become the main flow of the market. Just because the cross-cut shredders cut paper more tinny, so the motor that provide the drive revolving cut wheel must more powerful than that of stripe-cut shredders. Besides because the blade used for cutting of stripe-cut shredders is provided with more than one hook-shaped edges, to avoid accidentally injure operator on the circumstance of the current is not break, so ISO have a regulation that the shredders must have safe activation switch, namely, cross-cut shredders act only on the condition that be set on the fixed position of garbage container provided with manufacture, on the contrary, if the shredders being removed from the garbage container the current will be broken. So, as to the cross-cut shredders, shredders and the garbage container must be provided to consumers. But the regulation is not applied to stripe-cut shredders, so stripe-cut shredders can be sold lonely not plus compulsively garbage container, so the consumers who want not have a additional garbage or manufactures who want not increase the packing volume of suitable garbage container and transport cost, the garbage will be provided to consumers as a non-compulsive suitable object.

### SUMMARY OF THE INVENTION

Whereas those mentioned above, the inventor think of the possibility to combine cross-cut shredder and stripe-cut shredder into a unit, and invent a strip/cross double-duty shredder through long time study and test. The present invention provides a linkage mechanism to make double-duty shredders realize the effect of latitude cut and longitudinal cut and anti-block of chips. And, namely, the main object of the present invention is to provide a linkage mechanism of cut paper and anti-block of double-duty shredders to make latitudinal cut blade and longitudinal cut blade of double-duty fulfill the act of cut paper by the cross movement of crank coupler link device and intermittent cluster gear.

The second object of the present invention is to provide a linkage mechanism of cut paper and anti-block of double-duty shredders, to make the paper chips left in the groove of cutter be expel out by expeller to avoid paper block after latitudinal cutter blade cut the paper.

### BRIEF DESCRIPTION OF THE DRAWINGS

FIG. 1 is a perspective view of outline of double-duty shredder;

FIG. 2 is a general view of parts of double-duty shredder;

FIG. 3 is an exploded perspective view of the present invention;

FIG. 4 is a dynamic sectional view of the present invention.

### DESCRIPTION OF THE PREFERRED EMBODIMENT

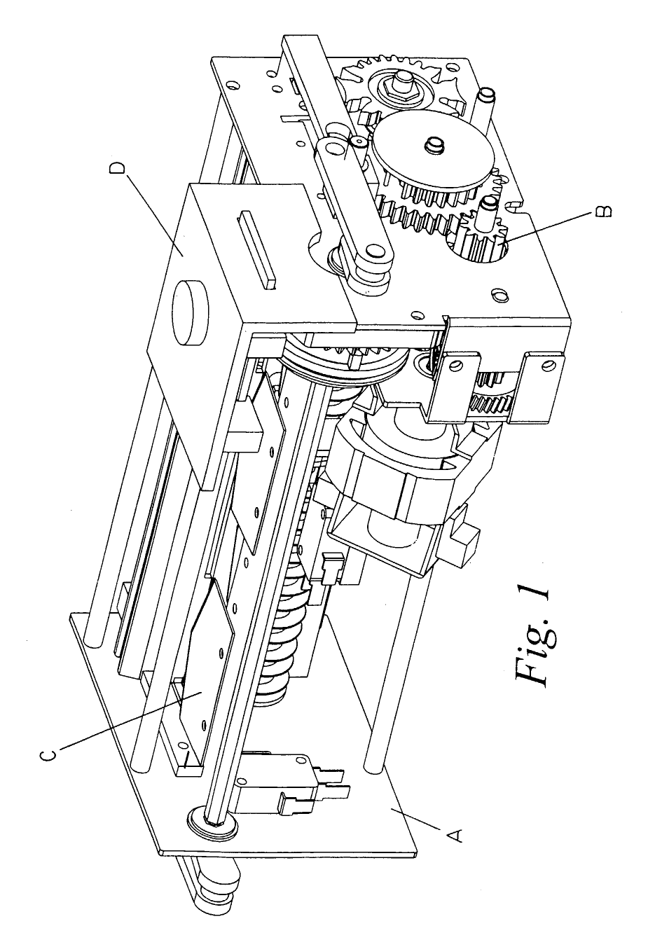

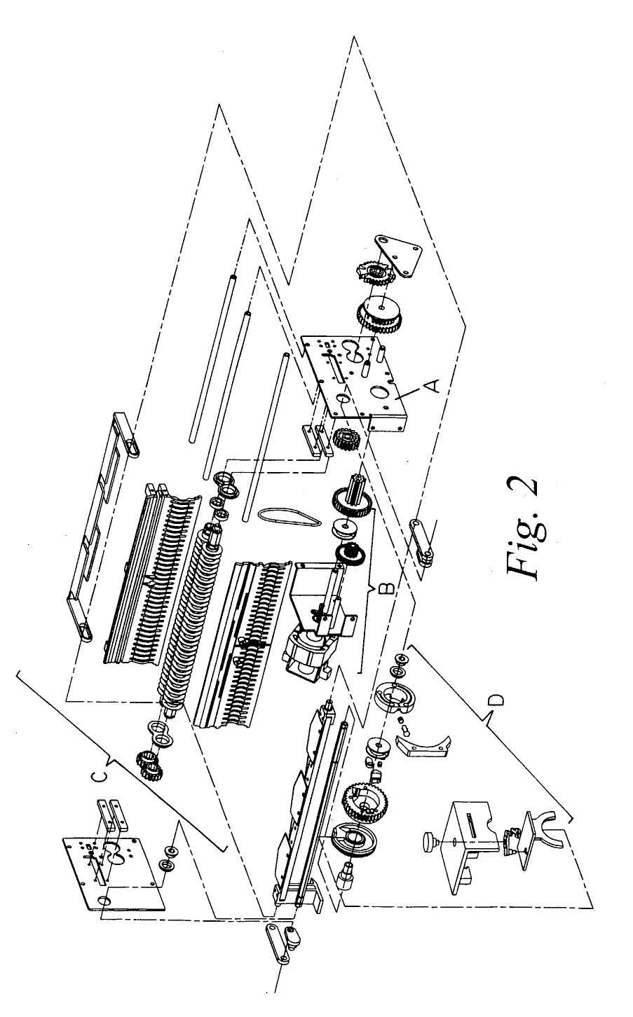

Please refer to the perspective view of outline of double-duty shredder shown in FIG. 1 and the view of parts of double-duty shown in FIG. 2. The double-duty shredder consists of main body A, motor drive mechanism B, linkage mechanism of latitude cut/longitudinal cut and anti-block C, and strip/cross switch mechanism D on the whole.

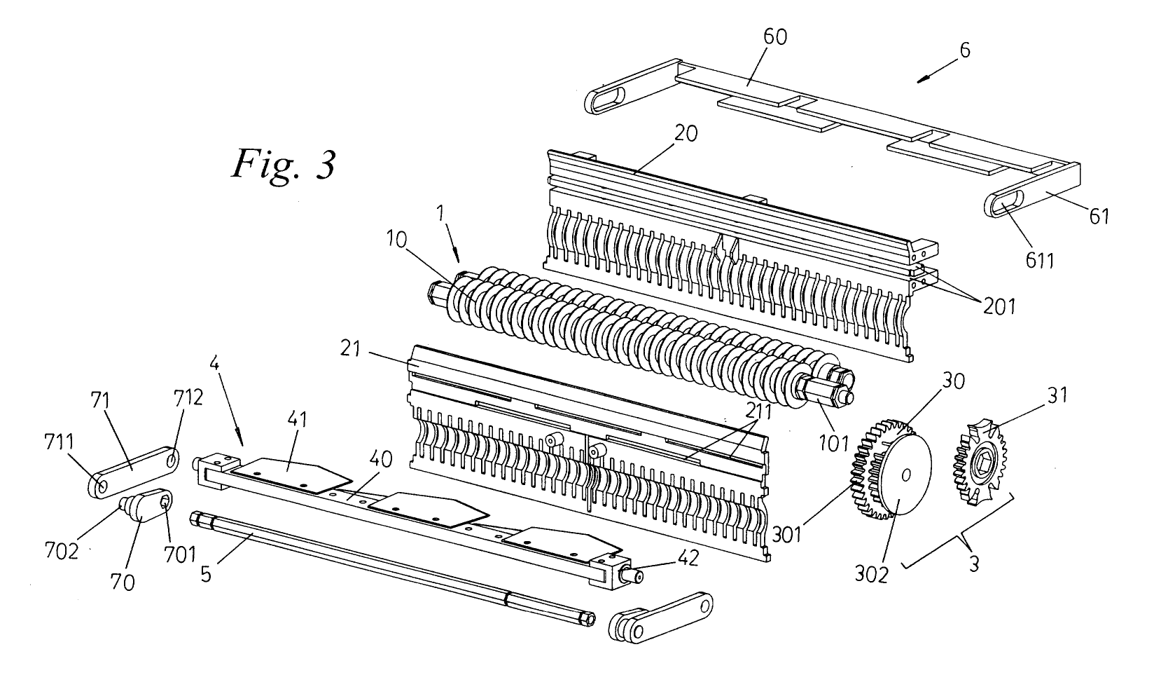

Please refer to the perspective explode view shown in FIG. 3, the present invention: linkage mechanism of paper-cut and anti-block of double-duty shredder, comprise:

Two opposite strip cutter wheel group 1 for longitudinal cut, is disposed between front paper-guide plate 20 and rear paper-guide plate 21, wherein the end of axis 101 of drive cutter wheel 10 is fixed to driven gear wheel 31 of intermittent cluster gear 3;

A latitudinal paper cutter 4 disposed on the left of rear paper-guide plate 21, and provided with cutter 41 on the top and bottom of quadrate cutter setting 40, a cutter rest 42 is fixed respectively to the two ends of cutter setting 40;

A drive shaft 5 disposed on the left of paper cutter 4 and get power supplied by motor B so can rotate;

A paper-expeller 6 disposed on the right of said paper-guide plate 20, is Π-shaped on the whole, is provided with paper-expel plate 60 and two side support arms 61, wherein, the end of support arm 61 having long-hole groove.

A crank coupler link group 7, wherein one end 701 of crank 70 is secured to said drive shaft 5, the other end 702 is secured to fixed end 711 of coupler link 71, the free end 712 of coupler link 71 is set in the long-hole groove 611 of two supporting arms 61 of said paper-expeller 6 after engaged with cutter rest 42 of said latitudinal paper-cutter 4.

A intermittent cluster gear 3, wherein drive gear 30 consists of normal gear wheel 301 and abnormal gear wheel 302, normal gear wheel 301 intermesh with motor drive gear wheel B to receive the rotate power and rotates driven gear wheel 31 intermeshed with normal gear wheel 31 and strip cutter wheel group 1.

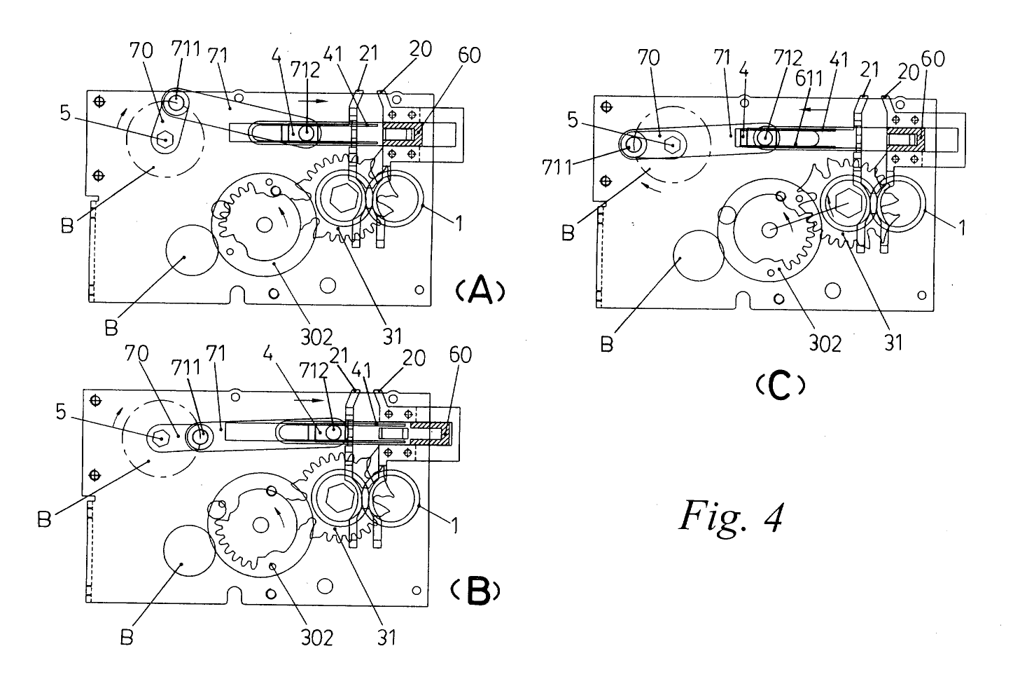

Please refer to FIG. 4, sectional view of embodiment of the present utility paten: linkage mechanism of paper-cut and anti-block of double-duty shredder, wherein, as shown in view A, coupler link 70 rotate clockwise roundly with drive shaft 5, free end 712 of coupler link 71 and latitude paper-cutter 4 will be driven and move right along the long-hole groove 611 of paper-expeller 6, two-layer cutter 41 prink to paper to be cut after through the pre-left cutter groove 211 of rear paper-guide plate 21, because the track length of circle movement of coupler link 70 is longer than the length of long-hole groove 611, so when the track length of circle movement of coupler link 70 is longer than the length of long-hole groove 611, the free end 712 of coupler link 71, as shown in view B, will compel paper-expeller 6 move right in latitude direction, the room left in the cutter groove 201 of front paper-guide plate 20 disposed on paper-expel plate 60 after paper-expel plate moved to right is can be exactly as the room that the two-layer cutter 41 move to the right deadpoint.

When two-layer cutter 41 finished prink the paper to be cut, as shown in view C, will rotate roundly with coupler link 70 and be pull back to left side by coupler link 71, and in the same way, when track length of circle rotate of coupler link 70 is longer than the length of long-hole groove 611, paper-expeller 6 will be compelled move left to make paper-expel plate 60 will move the paper chips left in the cutter groove 201 of paper-guide plate 20 alone the direction of strip cutter wheel group 1 to garbage container, to avoid paper chip store up cutter groove 201 of paper-guide plate 20 cause block.

Please pay attention to especially the strip cutter wheel group 1 is in a static state that not act when said latitude cutter 4 prick the paper to be cut, the reason is the strip cutter wheel group 1 have the effect to pull the paper to be cut down, and the paper to be cut cannot in a static state in the course of latitudinal cut, and it is obvious that the act of strip cutter wheel group 1 pulling the paper to be cut down will tear the paper to be cut. So the strip cutter wheel group 1 must be kept in static state in the course of latitudinal cutter 4 pricking the paper to be cut.

Please refers to the view A, B, C of FIG. 4, the drive gear wheel 30 of intermittent cluster gear 3 consists of normal gear wheel 301 and abnormal gear wheel 302, the normal gear wheel 301 intermeshes with motor drive gear wheel B to get rotate power and rotate the driven gear wheel 31 intermeshed with which and strip cutter wheel group 1. It can be seen form the draws, the intermittent gear wheel 3 group 3 is a incomplete gear wheel of special design, wherein, approximate quarter of the circle of abnormal gear wheel 302 has the drive function, the other part that have not teeth can not transfer power. The driven gear wheel 31 intermeshed with abnormal gear wheel 301 is provided symmetrically with parts having teeth and parts having no teeth, in other words, only when the parts having teeth of abnormal gear wheel 302 intermeshes with the parts having teeth of driven gear wheel 31 the driven gear wheel 31 will rotate strip cutter wheel group 1, otherwise, the strip cutter wheel group will lost the source of power and keep static.

It can be seen clearly from view A and B, the parts having teeth of abnormal gear wheel 302 is not intermesh with the parts having teeth of driven gear wheel 31, they are in slipping state, so strip cutter wheel group 1 will keep static state, the period of time that slipping movement needed will be provide to latitude cutter 4 to prick the paper to be cut.

In view C, the cutter rotates with crank 70 and is pulled back to left by coupler link 71 after finished pricking the paper to be cut; and then, the parts having teeth of abnormal gear wheel 302 intermeshes with the parts having teeth of driven gear wheel 31 and rotate strip cutter gear wheel 1 to pull paper to be cut down and cut longitudinally these paper. So, paper to be cut have been pricked by cutter 41 before be pulled down and be cut longitudinally by strip cutter gear wheel 1, so the effect of cutting paper will realize by the cross movement in circles of cutting the paper to be cut into paper chips.

We can conclude from the above mentioned, the present invention use the strip cutter gear wheel of stripe-cut shredder as longitudinal paper-cutter, the motor can be a smaller type than that of cross-cut shredder and will not confined by the ISO regulation that install compulsory active switch. Actually, the cross-cut shredder realize the effect of cut paper to be cut into chips by the latitude pricking of latitudinal cutter and he longitudinal cutting of said strip cutter wheel. The present is actually a new invention, and comply with the regulation for applying a patent.

What is claimed is:

1. A linkage mechanism of paper-cut and anti-block of double-duty shredder, comprising:
two opposite strip cutter wheel groups for longitudinal cutting disposed between front paper-guide plate and rear paper-guide plate, wherein the end of axis of drive cutter wheel is fixed to driven gear wheel of intermittent cluster gear;
a latitudinal paper cutter disposed on the left of rear paper-guide plate having set cutter on the top and bottom of quadrate cutter setting and a cutter rest fixed respectively to the two ends of cutter setting;
a drive shaft disposed on the left of paper cutter and get power supplied by motor so can rotate;
a general Π-shaped paper-expeller disposed on the right of said paper-guide plate having paper-expel plate and two side support arms, wherein, the end of support arm having long-hole groove;
a crank coupler link group, wherein, one end of crank is secured to said drive shaft and the other end is secured to fixed end of coupler link and the free end of coupler link is set in the long-hole groove of two supporting arms of said paper-expeller after engaged with cutter rest of said latitudinal paper-cutter;
an intermittent cluster gear, wherein drive gear consists of normal gear wheel that intermeshed with motor drive gear wheel to receive the rotate power and rotates driven gear wheel intermeshed with normal gear wheel and strip cutter wheel group and abnormal gear wheel.

2. The linkage mechanism of paper-cut and anti-block of paper of double-duty shredder according to the claim 1, wherein front, rear paper-guide plates are pre-provided with cutter groove that cutter pass through.

3. The linkage mechanism of paper-cut and anti-block of double-duty shredder according to claim 1, wherein the drive gear wheel and the driven gear wheel of intermittent cluster gear having incomplete teeth and when the parts having teeth intermesh with each other driven gear wheel will be rotated and, on the contrary, the driven gear wheel will keep static state when the two gear wheel in slipping static state.
